(19) United States
(12) Patent Application Publication
(10) Pub. No.: US 2015/0142527 A1
(43) Pub. Date: May 21, 2015

(54) ARCHITECTURE FOR A CONTACT CENTER WITH EMULATOR DRIVEN SELF CONTROL LOOP

(71) Applicant: Avaya Inc., Basking Ridge, NJ (US)

(72) Inventors: Dawid Nowak, Dublin (IE); Joseph Smyth, Galway (IE); Paul Kelly, Co. Galway (IE)

(73) Assignee: Avaya Inc., Basking Ridge, NJ (US)

(21) Appl. No.: 14/082,858

(22) Filed: Nov. 18, 2013

(51) Int. Cl. G06Q 10/06

(52) U.S. Cl. CPC G06Q 10/0639
USPC 705/7.38

(57) ABSTRACT

A contact center control loop system including a traffic generator module configured to produce simulated contact center traffic patterns, an aggregated historical data module configured to store and provide historical contact center data, and a contact center emulator configured to receive, as input, data representing the operational status of the contact center, the simulated traffic patterns from the traffic generator, and the historical data from the aggregated historical data module and to generate forecasts of contact center behavior based on such input.

### BACKGROUND

1. Field of the Invention

Embodiments of the present invention provide a system and a method for managing a contact center. More particularly, embodiments of the present invention provide a system and a method for predicting contact center activity and adjusting operational parameters of the contact center based on such predictions.

2. Description of Related Art

Contact centers are employed by many enterprises to service inbound and outbound contacts from customers. A typical contact center includes a switch and/or server to receive and route incoming packet-switched and/or circuit-switched contacts, and one or more resources, such as human agents and automated resources (e.g., Interactive Voice Response (IVR) units), to service the incoming contacts.

Contact centers distribute contacts, whether inbound or outbound, for servicing to any suitable resource according to predefined criteria. In many existing systems, the criteria for servicing the contact from the moment the contact center becomes aware of the contact until the contact is connected to an agent are client or operator-specifiable (i.e., programmable by the operator of the contact center), via a capability called vectoring. Normally, in present-day ACDs when the ACD system's controller detects an agent has become available to handle a contact, the controller identifies all predefined contact-handling queues for the agent (usually in some order of priority) and delivers to the agent the highest-priority, oldest contact that matches the agent's highest-priority queue. Generally, the only condition that results in a contact not being delivered to an available agent is where there are no contacts waiting to be handled.

The primary objective of contact center management is to maximize contact center performance and profitability. In order to achieve these objectives, contact center efficiency must constantly be monitored and optimized. To that end, contact centers are staffed with supervisors who are responsible for managing agents to ensure consistent performance of the contact center. Supervisors are trained to handle normal call traffic, but must also be prepared to handle exceptional situations. For example, if there is a sudden burst of activity in a contact center and all of the agents of that contact center are busy in handling callers/customers while a high volume of new requests are still coming into the contact center, the supervisor is expected to manage the situation and allocate resources in an efficient manner.

Currently, contact center management is generally performed in a reactionary manner in response to changes in system traffic and load. For example, supervisors may dynamically modify the operational parameters of a contact center in order to handle unanticipated traffic variations or in response to events that impact contact center resources. The reactionary nature of contact center management can result in valid decisions being made too late or invalid decisions being made too early. For example, the former situation may occur when a condition has persisted for some time before a supervisor is able to adjust system parameters. The latter situation may occur due to sudden but short-lived spikes in traffic that could be absorbed by existing infrastructure without requiring reallocation of resources. In either case, contact center utilization will be suboptimal, resulting in increased cost to the contact center operator.

### SUMMARY

In view of the foregoing, it would be advantageous to provide a system and method capable of assisting contact center personnel in optimizing contact center efficiency and reducing contact center operating costs.

Embodiments in accordance with the present invention provide a contact center control loop system. The contact center control loop system includes a traffic generator module configured to produce simulated contact center traffic patterns, an aggregated historical data module configured to store and provide historical contact center data, and a contact center emulator configured to receive, as input, data representing the operational status of the contact center, the simulated traffic patterns from the traffic generator, and the historical data from the aggregated historical data module and to generate forecasts of contact center behavior based on such input.

Embodiments in accordance with the present invention further provide a computer-implemented method for establishing a contact center control loop system. The computer-implemented method includes feeding data representing the operational state of a contact center into a contact center emulator which runs in parallel with the contact center, feeding aggregated historical contact center data into the contact center emulator, feeding simulated traffic patterns into the contact center emulator, and using the contact center emulator to generate, based on the data representing the operational state of a contact center, the aggregated historical contact center data, and the simulated traffic patterns, forecasts of contact center behavior.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible, utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 is a schematic diagram illustrating an exemplary contact center in accordance with an embodiment of the present invention.

FIG. 2 is a schematic diagram illustrating an exemplary contact center control loop system in accordance with an embodiment of the present invention.

FIG. 3 is flow diagram illustrating an exemplary method of implementing the contact center control loop system in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The present invention will be illustrated below in conjunction with an exemplary communication system, e.g., the Avaya Aura® system. Although well suited for use with, e.g., a system having an ACD or other similar contact processing switch, the present invention is not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The terms “component” and “module” as used herein refer to any known or later developed hardware, software, firmware, artificial intelligence, fuzzy logic, or combination of hardware and software that is capable of performing the functionality associated with the referenced element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

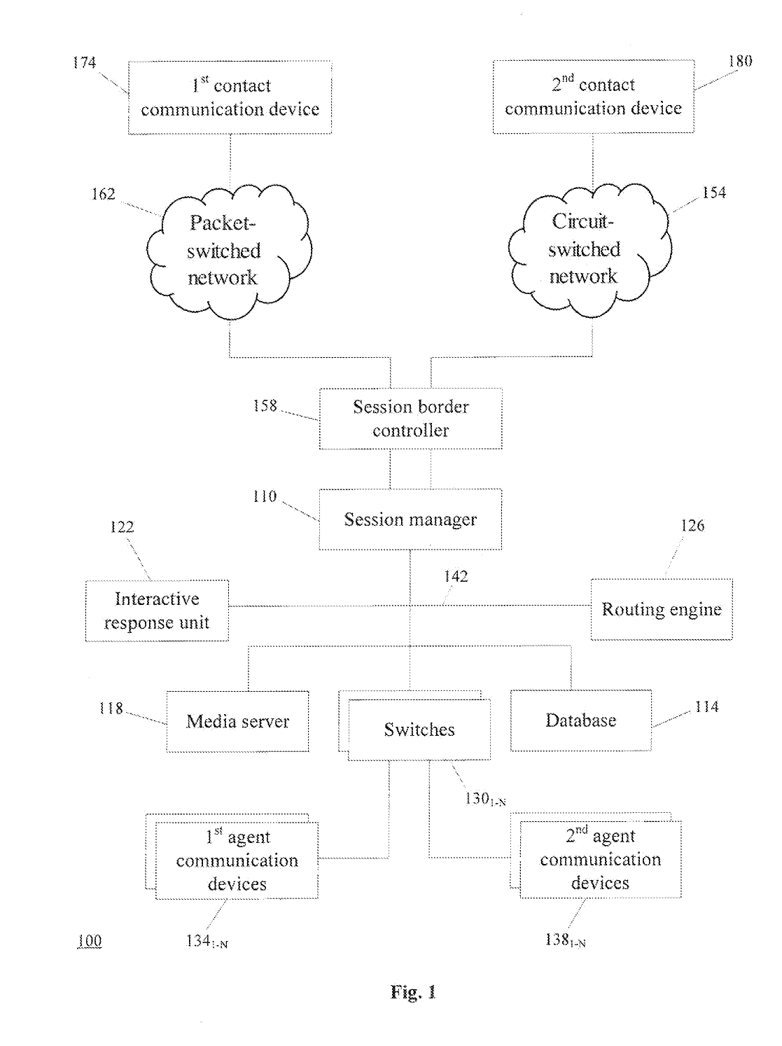

FIG. 1 shows an illustrative embodiment of a contact center 100 in accordance with the present invention. The contact center 100 may include a session manager 110, a set of data stores or databases 114 containing contact or customer related information and other information that can enhance the value and efficiency of contact processing, and a plurality of servers, namely a media server 118, an interactive response unit (e.g., IVR) 122, a routing engine 126, and switches 130_{1-N}, all interconnected by a local area network LAN (or wide area network WAN) 142 or other network connection technologies. A plurality of working agents operating packet-switched 1st agent communication devices 134_{1-N} (such as computer work stations or personal computers), and/or circuit-switched 2^{nd} agent communication devices 138_{1-N} may be connected to respective switches 130_{1-N}.

The session manager 110 is further connected to a circuit switched network 154 (e.g., a Public Switch Telephone Network or PSTN) and a packet switched network 162 (e.g., a distributed processing network, such as the Internet). The packet-switched network 162 is in communication with one or more external first contact communication devices 174, and the circuit-switched network 154 with one or more external second contact communication devices 180, used by customers to communicate with the contact center 100. A session border controller 158 is positioned between the session manager 110 and the networks 154 and 162 for processing communications passing between the session manager 110 and the networks 154 and 162 as further described below.

Although the preferred embodiment is discussed with reference to client-server architecture, it is to be understood that the principles of the present invention apply to other network architectures. For example, the present invention applies to peer-to-peer networks, such as those envisioned by the Session Initiation Protocol. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Additionally, the present invention does not require the presence of packet- or circuit-switched networks. The term “switch” or “server” as used herein should be understood to include a PBX, an ACD, an enterprise switch, an enterprise server, or other type of telecommunications system switch or server, as well as other types of processor-based communication control devices such as media servers, computers, adjuncts, etc.

In one embodiment, the session border controller 158 of the contact center 100 may be Avaya Inc.'s, G700 Media Gateway™, which may be implemented as a hardware component, such as via an adjunct processor or as a chip onboard the server. The session border controller 158 is responsible for providing the contact center 100 with a security gateway for protecting the contact center 100 from malicious attacks, toll fraud, malformed packets, and the like. It will be appreciated by those of ordinary skill in the art that the session border controller 158 may perform a variety of other functions, such as facilitating network connectivity, monitoring quality of service, and providing regulatory support.

The session manager 110 is responsible for routing and managing contacts inside of the contact center 100 (i.e., after the contacts have been admitted to the contact center 100 by the session border controller 158). Particularly, the session manager 110 communicates with the other SIP enabled devices (e.g., the media server 118, ICR 122, routing engine 126, and switches 130_{1-N}) in the contact center 100 and is configured with routing and dial plans to facilitate appropriate forwarding of incoming contacts as designated by the routing engine 126 as further described below.

The routing engine 126 is responsible for determining where, within the contact center 100, incoming contacts should be routed to and notifying the session manager 110 accordingly. For example, the routing engine 126 may receive a notification from the session manager 110 indicating that an incoming contact has been received. The routing engine 126 may then scan an internal database for available resources (e.g., agents, the media server 118, etc.) within the contact center 100 which are best suited to handle that particular contact. The routing engine 126 may access customer/contact information stored in the database(s) 114 in order to make such a determination. The routing engine 126 may then transmit a response back to the session manager 110 indicating the specific resource to which the contact should be routed. For example, the routing engine 126 may indicate to the session manager 110 that, based on the language requirements of a particular contact, that contact should be routed to an appropriate agent at a particular one of the 1st agent communication devices 134_{1-N} via a respective one of the switches 130_{1-N}.

The interactive response unit or IVR 122 provides an interactive, automated menu system for allowing incoming contacts to at least partially navigate to an appropriate resource within the contact center 100. For example, an incoming contact may be connected to the IVR 122, may select options to navigate through an automated menu, and may thereby be connected to an appropriate/desired resource without tying up contact center personnel. The IVR 122 may also perform other functions that will be familiar to those of ordinary skill in the art, such as allowing a contact to select a preferred language of communication, based on which the IVR system may intelligently route the contact to an agent who is fluent in the selected language.

The media server 118 of the contact center 100 is responsible for playing treatment messages for contacts when appropriate. Such treatment messages may include prerecorded announcements (e.g., “an agent will be with you shortly”), on-hold music, etc. The particular format of the treatment message may depend on the type of contact received. For example, video chat contacts may receive video messages, while phone call contacts may receive voice messages.

The first agent communication devices 134_{1-N} are packet-switched devices that may include, for example, IP hardphones such as the Avaya Inc.'s, 4600 Series IP Phones™, IP softphones such as Avaya Inc.'s, IP Softphone™, Personal Digital Assistants or PDAs, Personal Computers or PCs, laptops, packet-based H.320 video phones and conferencing units, packet-based voice messaging and response units, packet-based traditional computer telephony adjuncts, peer-to-peer based communication devices, and any other communication device.

The second agent communication devices 138_{1-N} are circuit-switched devices. Each of the second agent communication devices 138_{1-N} corresponds to one of a set of internal extensions Ext_{1-N}, respectively. The second agent communication devices 138_{1-N} can include, for example, wired and wireless telephones, PDAs, H.320 videophones and conferencing units, voice messaging and response units, traditional computer telephony adjuncts, and any other communication device.

It should be noted that the present invention does not require any particular type of information transport medium between switch or server and first and second communication devices, i.e., the present invention may be implemented with any desired type of transport medium as well as combinations of different types of transport channels.

It should be emphasized the particular configuration of the contact center 100 shown in FIG. 1, including all of the components thereof, is presented for purposes of illustration only and should not be construed as limiting the present invention to any particular arrangement of elements.

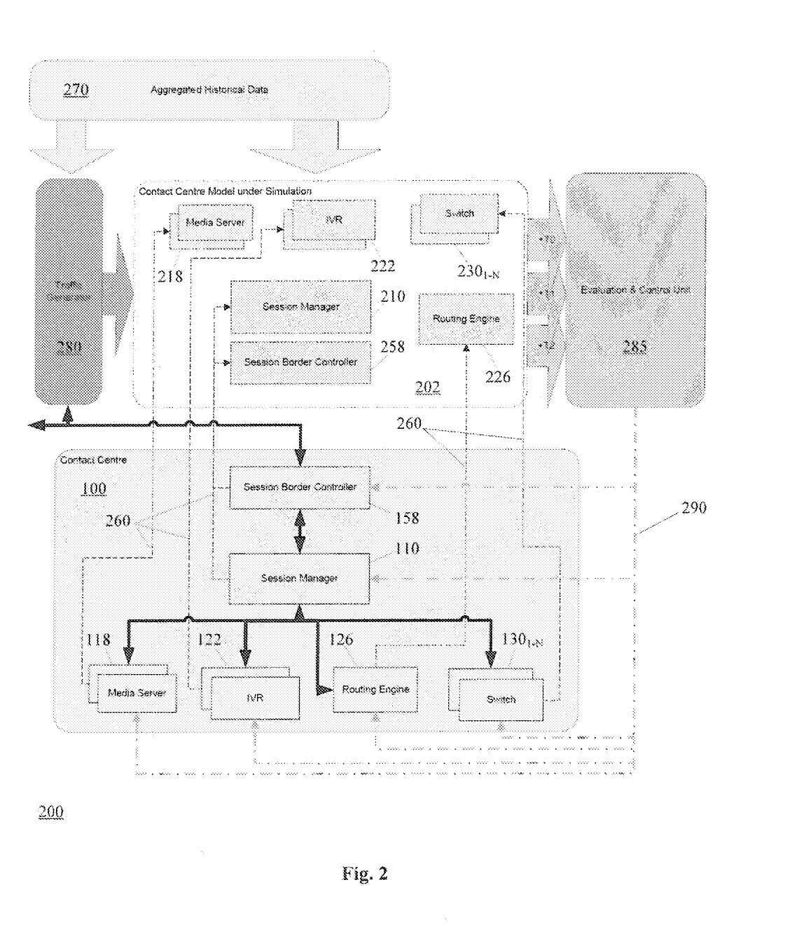

Referring to FIG. 2, a schematic representation of an exemplary contact center control loop system 200 (hereinafter “the system 200”) in accordance with the present disclosure is illustrated. The system 200 includes the above-described call center 100, a simplified schematic representation of which is illustrated in FIG. 2. The system 200 further includes a contact center emulator 202 (hereinafter “the emulator 202”). The emulator 202 is a software model of the contact center 100 that resides on a computing platform (e.g., a server) within the contact center environment. Alternatively, it is contemplated that the emulator 202 may reside on a computing platform that is remote from the contact center 100 environment and is operatively connected to the contact center 100 via wired or wireless network connection, such as via the Internet using transmission control protocol and Internet protocol (TCP/IP). The emulator 202 may be deployed as an integral component of the contact center 100, or may be implemented as an add-on feature subsequent to establishment of the contact center 100.

The emulator 202 includes software models of several components of the contact center 100, including a session manager model 210, a media server model 218, an IVR model 222, a routing engine model 226, switch models switches 230_{1-N}, and a session border controller model 258. These software models are configured to individually and cooperatively emulate the operation of their corresponding components in the contact center 100. For example, the routing engine model 226 of the emulator 202 may operate according to similar algorithms and may be configured to route contact traffic according to similar parameters as those of the routing engine 126 of the contact center 100.

During normal operation of the system 200, the various components of the contact center 100 may process inbound and outbound contact center traffic in a conventional manner as described above. For example, the session border controller 158 may perform gateway functions (e.g., security functions) and the session manager 130 may route contact traffic to various contact center resources (e.g., the media server 118, the IVR 122, and the agents via the switches 130_{1-N}) according to input from the routing engine 126. While the contact center 100 processes traffic thusly, the emulator 202 simultaneously and continuously operates in parallel with, or “shadows,” the contact center 100. Particularly, operational data representing the current state of each of the components of the contact center 100 is constantly communicated to each of the components' respective software models within the emulator 202. Such data transmission is represented by the dashed lines 260 in FIG. 2. The transmitted data is then processed by the components of the emulator 202. The emulator 202 thereby substantially mirrors the operation of the contact center 100 and continuously monitors trends in contact center traffic patterns and component utilization.

In addition to the data transmitted from the components of the contact center 100 to the software models within the emulator 202, an aggregated historical data module 270 feeds historical contact center data into the emulator 202. The historical data may include, for example, operational data that was previously transmitted by the components of the contact center 100, as well as similar data previously derived from other contact centers. These data are representative of past contact center events, as well as trends and patterns in contact center component utilization and resource allocation. For example, the historical data may indicate how well particular volumes of contact center traffic were handled by a particular number of agents over time. The aggregated historical data module 270 may reside on the same server as the emulator 202. Alternatively or additionally, the aggregated historical data module 270 may reside on a computing platform that is remote from the contact center environment.

The system 200 may also include a traffic generator module 280. The traffic generator module 280 is a software component that receives, as input, data representative of contact traffic that enters the contact center 100, as well as data from the aggregated historical data module 270 relating to past contact center traffic patterns, trends, and/or distributions. The traffic generator module 280 uses these data to create simulated, predictive traffic patterns that are subsequently fed into the emulator 202 in order to prospectively determine the operational effects of such patterns as further described below. For example, the traffic generator module 280 may determine that a traffic pattern exhibited by current contact center traffic data is, according to historical data, often followed by a particular, subsequent traffic pattern. The traffic generator module 280 may then generate such a predicted traffic pattern and feed it into the emulator 202. The traffic generator module 280 may reside on the same server as the emulator 202 or may reside on a computing platform that is remote from the contact center environment.

During operation, the emulator 202 may correlate the operational data received from the components of the contact center 100 with the historical data from the aggregated historical data module 270 and the simulated traffic produced by the traffic generator module 280 in order to generate a number of short, medium, and long term forecasts of contact center performance. Each forecast may be predicated upon a different combination of key operational factors of the contact center 100. Such operational factors may include, but are not limited to, traffic volumes and the number and availability of agents and/or other contact center resources.

Multiple forecasts may therefore be generated in parallel for different times in the future. For example, a plurality of “short term” predictions based on the correlated data and various combinations of key operational factors may be made for a specified time T₀ that may be in a range of about 1 to 5 minutes in the future. Similarly, a plurality of “medium term” predictions may be made for a specified time T₁ that may be in a range of about 15 to 30 minutes in the future, and a plurality of “long term” predictions may be made for a specified time T₂ that may be 1 hour or more in the future. It will be appreciated that the aforementioned ranges for the short, medium, and long term predictions are provided by way of example only and may be varied without departing from the present disclosure. It is contemplated that the predictions may be updated continuously or at predetermined intervals (e.g., every 5 minutes).

The operational forecasts generated by the emulator 202 are input into an evaluation and control unit 285 which, based on the forecasts, will determine whether alarms and/or notifications must be issued and/or whether the operational parameters of the contact center 100 must be automatically modified. Particularly, the evaluation and control unit 285 will evaluate the provided forecasts in view of the then current operational parameters of the contact center 100 and will identify probable deficiencies and inefficiencies that may arise in the future.

For example, the evaluation and control unit 285 may determine that there is an insufficient number of available agents in the contact center 100 to handle a forecasted surge in call center traffic, and that such a surge will result in unacceptably long wait times for many incoming contacts. As a result of making such a determination, the evaluation and control unit 285 may issue a notification or may activate an alarm to indicate to a system operator (e.g., a contact center supervisor) that various preventative or compensatory measures should be taken. Such measures may include, but are not limited to, reallocating agents (e.g., routing incoming sales calls to customer service agents who do not normally handle sales), routing incoming contacts to the media server 118 to receive a notification of long wait times, or instructing the session border controller 158 and/or the session manager 110 to drop calls.

In addition or in alternative to issuing notifications and/or activating alarms in the manner described above, the evaluation and control unit 285 may execute the aforementioned preventative measures automatically, such as by exerting direct control over the components of the contact center 100 as indicated by the dashed lines 290 shown in FIG. 2. In one non-limiting example, the evaluation and control unit 285 may be configured to exert automatic control over the contact center 100 if it is determined that changes must be implemented rapidly to mitigate particularly detrimental situation that is forecasted to occur in the very near future, whereas notifications and/or alarms may be issued for less critical situations or situations which may be forecasted to occur further into the future. In the case of automatic action, system operators may be provided with the ability to override the evaluation and control unit 285.

In performing its analysis of the various forecasts provided by the emulator 202, the evaluation and control unit 285 may accord greater weight to shorter term forecasts and less weight to longer term forecasts. This is because shorter term forecasts rely on fewer assumptions regarding future events and conditions and will therefore be more accurate and more reliable than longer term forecasts.

The accuracy of the forecasts generated by the emulator 202 may be constantly evaluated through comparison with the actual state of the contact center 100 at the forecasted times. If the forecasts do not converge with, or closely follow, the data representing the operational state of the contact center 100 (e.g., if the accuracy of the forecasts falls below a predetermined value), the parameters dictating the behavior of emulator 202 may be adjusted in a compensatory manner until such convergence or close tracking is achieved.

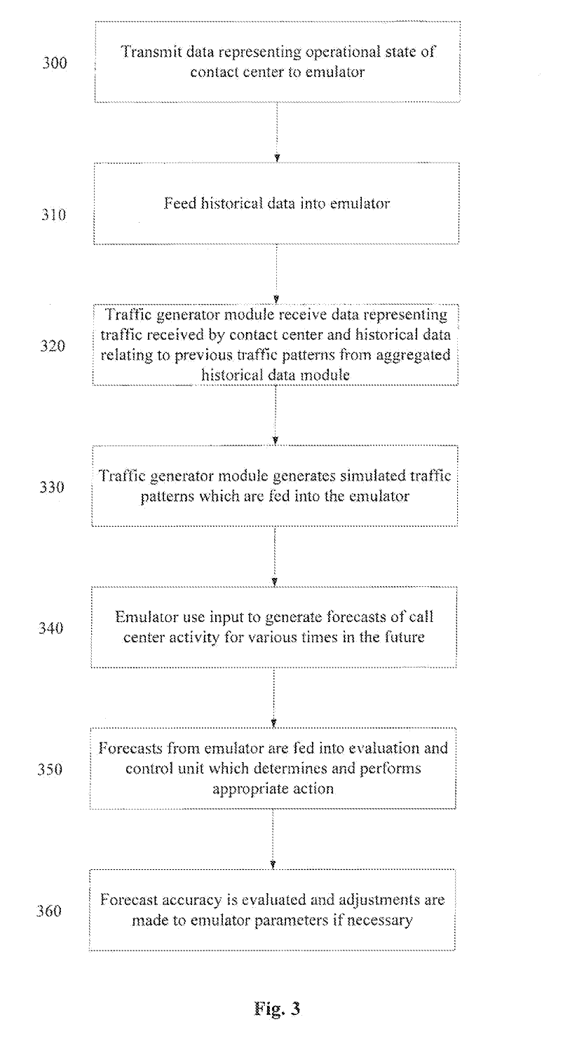

Referring to FIG. 3, a flow diagram illustrating an exemplary method for implementing a contact center control loop system in accordance with the present disclosure is shown. Such method will now be described in conjunction with the schematic representation of the system 200 shown in FIG. 2.

At a first step 300 of the exemplary method, data representing the operational state of the contact center 100 is transmitted to the software emulator 202 which runs in parallel with the contact center 100. This may include transmitting operational data from one or more individual components of the contact center 100 to corresponding software models within the emulator 202.

At step 310, historical data from the aggregated historical data module 270 is fed into the emulator 202. The historical data may include, for example, operational data that was previously transmitted by the components of the contact center 100 (as in step 300), as well as similar data previously derived from other contact centers. These data may be representative of past contact center events, as well as trends and patterns in contact center component utilization and resource allocation.

At step 320, the traffic generator module 280 receives, as input, data representative of traffic that enters the contact center 100, as well as data from the aggregated historical data module 270 relating to past contact center traffic patterns, trends, and/or distributions. At step 330, the traffic generator module 280 uses the received input to create simulated traffic patterns that are subsequently fed into the emulator 202.

At step 340 of the exemplary method, the emulator 202 correlates the operational data transmitted from the components of the contact center 100 (from step 300) with the aggregated historical data 270 (from step 310) and the simulated traffic provided by the traffic generator 280 (from steps 320 and 330) in order to generate a number of short, medium, and long term forecasts of contact center performance. These forecasts may include a number of short term forecasts for a time T₀ in the future, a number of medium term forecasts for a time T₁ in the future, and a number of long term forecasts for a time T₂ in the future.

At step 350 of the exemplary method, the forecasts generated by the emulator 202 are fed into the evaluation and control unit 285, which, based on the forecasts, determines whether alarms and/or notifications must be issued and/or whether the operational parameters of the contact center 100 must be automatically modified. For example, if it is predicted that a particularly critical situation may arise in the very near future, the evaluation and control unit 285 may modify operational parameters (e.g., reallocate agents, drop contacts, initiate special media messages, etc.) automatically. If a forecasted situation is not particularly critical, the evaluation and control unit 285 may simply issue notifications for consideration by contact center personnel.

At step 360 of the exemplary method, the accuracy of the forecasts generated by the emulator 202 may be evaluated through comparison with the actual state of the contact center 100 at the forecasted periods. If it is determined that the forecasts lack accuracy, the parameters dictating the behavior of emulator 202 may be adjusted in a compensatory manner until a desired level of accuracy is achieved.

It will be appreciated from the above description that the system 200 and corresponding method provide contact center administrators with the ability to make highly-informed decisions with regard to the effective allocation of contact center resources. Contact centers that implement the system 200 may therefore be operated more efficiently and at a lower cost to their operators relative to conventional contact centers.

The exemplary systems and methods of this present invention have been described in relation to a contact center. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example, in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A contact center control loop system comprising:
a traffic generator module configured to produce simulated contact center traffic patterns;
an aggregated historical data module configured to store and provide historical contact center data; and
a contact center emulator configured to receive, as input, data representing the operational status of the contact center, the simulated traffic patterns from the traffic generator, and the historical data from the aggregated historical data module, and to generate forecasts of contact center behavior based on such input.

2. The contact center control loop system of claim 1, further comprising an evaluation and control unit configured to receive the forecasts from the contact center emulator and to determine, based on such forecasts, whether to issue notifications to contact center personnel.

3. The contact center control loop system of claim 1, further comprising an evaluation and control unit configured to receive the forecasts from the contact center emulator and to determine, based on such forecasts, whether to automatically modify operational parameters of the contact center.

4. The contact center control loop system of claim 1, wherein the forecasts include a short term forecast for a time T₀ in the future, a medium term forecast for a time T₁ in the future, and long term forecast for a time T₂ in the future.

5. The contact center control loop system of claim 1, wherein the contact center emulator comprises a plurality of software models that are configured to emulate the operation of corresponding components in the contact center.

6. The contact center control loop system of claim 1, wherein the traffic generator module is configured to receive, as input, data representing traffic being received by the contact center as well as data from the aggregated historical data module relating to past contact center traffic patterns.

7. The contact center control loop system of claim 1, wherein the contact center emulator is configured to evaluate the accuracy of its forecasts based on the actual behavior of the contact center at forecasted times and to adjust its operational parameters in a compensatory manner if the accuracy does not meet a predetermined minimum threshold.

8. A contact center control loop system comprising:
a contact center comprising a plurality of operational components;
an aggregated historical data module configured to store and provide historical data from the contact center;
a traffic generator module configured to produce simulated contact center traffic patterns based on current contact center traffic as well as data from the aggregated historical data module relating to past contact center traffic patterns;
a contact center emulator comprising software models of each of the operational components of the contact center, wherein each of the software models is configured to receive, as input, data representing the operational status of its corresponding operational component in the contact center, wherein such data is correlated with the simulated traffic patterns from the traffic generator and the historical data from the aggregated historical data module to generate forecasts of contact center behavior; and
an evaluation and control unit configured to receive the forecasts from the contact center emulator and to determine, based on such forecasts, whether to execute certain predefined actions.

9. The contact center control loop system of claim 8, wherein the predefined actions include issuing notifications to contact center personnel.

10. The contact center control loop system of claim 8, wherein the predefined actions include automatically modifying operational parameters of the contact center.

11. The contact center control loop system of claim 8, wherein the forecasts include a short term forecast for a time T₀ in the future, a medium term forecast for a time T₁ in the future, and long term forecast for a time T₂ in the future.

12. The contact center control loop system of claim 8, wherein the contact center emulator is configured to evaluate the accuracy of its forecasts based on the actual behavior of the contact center at forecasted times and to adjust its operational parameters in a compensatory manner if the accuracy does not meet a predetermined minimum threshold.

13. The contact center control loop system of claim 8, wherein the aggregated historical data module includes historical data from other contact centers.

14. A method for providing a contact center control loop system comprising:
feeding data representing the operational state of a contact center into a contact center emulator which runs in parallel with the contact center;
feeding aggregated historical contact center data into the contact center emulator;
feeding simulated traffic patterns into the contact center emulator; and
using the contact center emulator to generate, based on the data representing the operational state of a contact center, the aggregated historical contact center data, and the simulated traffic patterns, forecasts of contact center behavior.

15. The method of claim 14, further comprising feeding the forecasts generated by the emulator into an evaluation and control unit and, based on such forecasts, issuing notifications to contact center personnel.

16. The method of claim 14, further comprising feeding the forecasts generated by the emulator into an evaluation and control unit and, based on such forecasts, automatically modifying operational parameters of the contact center.

17. The method of claim 14, wherein the step of generating forecasts of contact center behavior comprises generating a short term forecast for a time T₀ in the future, a medium term forecast for a time T₁ in the future, and a long term forecast for a time T₂ in the future.

18. The method of claim 14, further comprising evaluating the accuracy of the forecasts generated by the contact center emulator based on the actual behavior of the contact center at forecasted times and adjusting the operational parameters of the contact center emulator in a compensatory manner if the accuracy does not meet a predetermined minimum threshold.

19. The method of claim 14, further comprising generating the simulated traffic patterns based on data representing current traffic entering the contact center as well as data relating to past contact center traffic patterns.

20. The method of claim 14, wherein the step of feeding data representing the operational state of a contact center into a contact center emulator comprises feeding data relating to the operational status of various components of the contact center into corresponding software models of the components in the contact center emulator.
